(19) United States
(12) Patent Application Publication
(10) Pub. No.: US 2011/0302338 A1
(43) Pub. Date: Dec. 8, 2011

(54) MICROCONTROLLER

(75) Inventors: Yi-Long Yang, Tainan County (TW); Yaw-Guang Chang, Tainan County (TW)

(73) Assignee: HIMAX TECHNOLOGIES LIMITED, Tainan County (TW)

(21) Appl. No.: 12/794,938

(22) Filed: Jun. 7, 2010

(51) Int. Cl. G06F 3/00; G06F 12/02; G06F 12/00

(52) U.S. Cl. 710/51; 711/154; 711/103; 711/E12.001; 711/E12.008

(57) ABSTRACT

A microcontroller is disclosed, which includes a memory, a first storage unit, a plurality of second storage units, a multiplexer and a micro-controller unit (MCU). The first storage unit is for being written into with a first code. The second storage units are for being written into with a plurality of second codes. The multiplexer writes the first code and one of the said second codes into the memory according to a control signal so that the memory generates a system code. The MCU reads out the system code come from the memory to perform operations.

### BACKGROUND OF THE INVENTION

1. Field of the Invention

The present invention generally relates to a microcontroller, and more particularly, to a microcontroller able to be multiple-times written into with system codes.

2. Description of Related Art

The current touch-control technique usually employs a microcontroller therein used for numerical operations. FIG. 1 is a structure diagram of a microcontroller in the conventional touch-control technique. Referring to FIG. 1, a microcontroller 100 includes a micro-controller unit 110 (MCU 110), a static random access memory 120 (SRAM 120) and a one-time programmable memory 130 (OTP memory 130).

The MCU 110 would store system codes through the SRAM 120. Since the system code is different somehow to meet the requirements of client terminals, so that the microcontroller 100, for saving the cost, employs an OTP memory 130 for the client terminal to write the required system code. In this way, when the microcontroller 100 is started, the system code written into OTP memory 130 would be transmitted to the SRAM 120. The MCU 110 correspondingly reads out the system code from the SRAM 120, followed by performing the related numerical operation.

The OTP memory 130 is advantageous in low cost; however, the scheme is restricted by providing the client terminal with only one chance of burning. Therefore, how to provide a multiple-times programming function in association with considering the hardware cost of the microcontroller has become an important task to be solved in designing a microcontroller.

### SUMMARY OF THE INVENTION

Accordingly, the present invention is directed to a microcontroller able to be multiple-times written into with system codes in association with considering the hardware cost of the microcontroller.

The present invention provides a microcontroller, which includes a memory, a first storage unit, a plurality of second storage units, a multiplexer and a micro-controller unit. The first storage unit is for being written into with a first code. The second storage units are for being written into with a plurality of second codes. The multiplexer writes the first code and one of the said second codes into the memory according to a control signal so that the memory generates a system code. The micro-controller unit reads out the system code come from the memory to perform operations.

In an embodiment of the present invention, the storage space of the above-mentioned first storage unit is respectively greater than the storage space of each of the second storage units.

In an embodiment of the present invention, the above-mentioned multiplexer includes a first input terminal, a plurality of second input terminals and an output terminal. In addition, the first input terminal of the multiplexer is coupled to the first storage unit, the second input terminals thereof are coupled to the second storage units, the output terminal thereof is coupled to the memory, and the multiplexer selects one of the second input terminals according to the control signal and sequentially conducts the first input terminal and the selected second input terminal to the output terminal.

In an embodiment of the present invention, the above-mentioned first storage unit and second storage units are respectively a one-time programmable memory, and the above-mentioned memory is a static random access memory (SRAM).

Based on the depiction above, the present invention uses the multiplexer to write the first code and one of the second codes into the memory, so that the present invention is able to use the first code and the different second codes to realize multiple-times programming function with the system codes. In addition, the system code herein is composed mainly of the first code, so that the storage space of the second storage units for accessing the second codes can be relatively compressed, which is advantageous in reducing the hardware cost of the microcontroller.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a structure diagram of a microcontroller in the conventional touch-control technique.

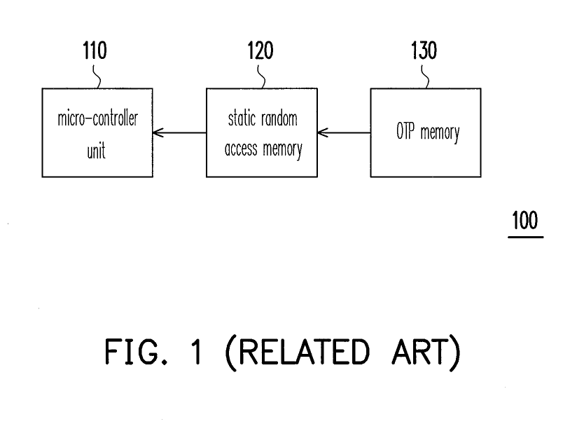

FIG. 2 is a structure diagram of a microcontroller according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

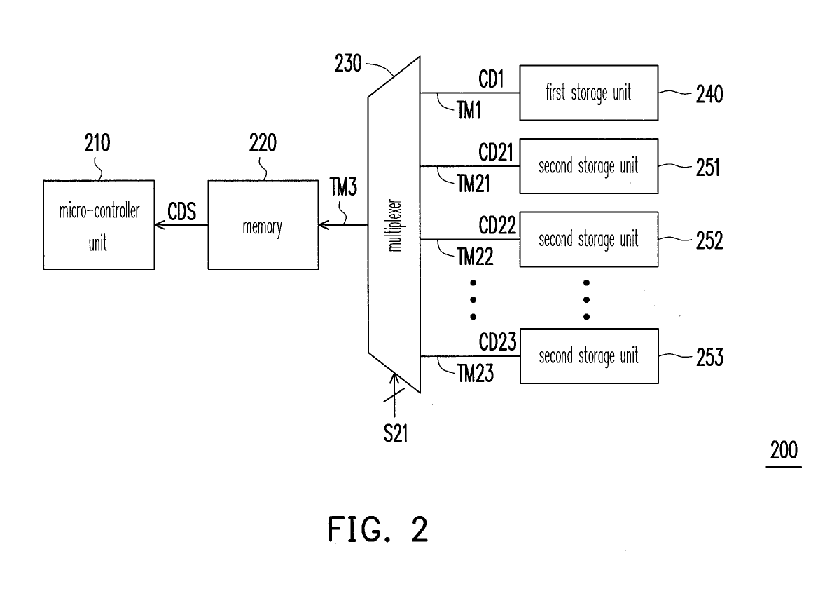

FIG. 2 is a structure diagram of a microcontroller according to an embodiment of the present invention. As shown in FIG. 2, a microcontroller 200 includes an MCU 210, a memory 220, a multiplexer 230, a first storage unit 240 and a plurality of second storage units 251-253. The memory 220 is coupled to the MCU 210. In addition, the multiplexer 230 includes a first input terminal TM1, a plurality of second input terminals TM21-TM23 and an output terminal TM3. The first input terminal TM1 of the multiplexer 230 is coupled to the first storage unit 240, the second input terminals TM21-TM23 of the multiplexer 230 are correspondingly coupled to the second storage units 251-253, and the output terminal TM3 of the multiplexer 230 is coupled to the memory 220.

In the operations, the first storage unit 240 can be written into with a first code CD1, while the second storage units 251-253 can be respectively written into with a second code. For example, a second code CD21 is written into the second storage unit 251, a second code CD22 is written into the second storage unit 252 and a second code CD23 is written into the second storage unit 253. In other words, after the codes are written into the first storage unit 240 and the second storage units 251-253, the multiplexer 230 would receive the first code CD1 and the second codes CD21-CD23.

The multiplexer 230 is controlled by a control signal S21. Here, the multiplexer 230 selects one of the second input terminals TM21-TM23 according to the control signal S21 and then sequentially turns on the path between the first input terminal TM1 and the output terminal TM3 and the path between the selected second input terminal and the output terminal TM3. In this way, when the second input terminal TM21 is selected by the multiplexer 230, the first code CD1 come from the first storage unit 240 and the second code CD21 come from the second storage unit 251 would be sequentially written into the memory 220 so that the memory 220 generates a system code CDS. As a result, when the microcontroller 200 is started, the MCU 210 would read out the system code CDS from the memory 220, followed by performing the related numerical operation.

On the other hand, when the second input terminal TM22 is selected by the multiplexer 230, the first code CD1 come from the first storage unit 240 and the second code CD22 come from the second storage unit 252 would be sequentially written into the memory 220 so that the memory 220 generates a system code CDS. When the second input terminal TM23 is selected by the multiplexer 230, the first code CD1 come from the first storage unit 240 and the second code CD23 come from the second storage unit 253 would be sequentially written into the memory 220 so that the memory 220 generates a system code CDS.

Namely, the first code CD1 and one of the second codes CD21-CD23 are written into the memory 220 by using the multiplexer 230 to switch the first storage unit 240 and the second storage units 251-253. Thereby, the memory 220 would generate the system code CDS according to the first code CD1 and one of the second codes CD21-CD23. In other words, the system code CDS is generated by the first code CD1 and a second code. In the application, a user can select different second codes through the multiplexer 230 to realize updating the system code CDS and thereby solve the problem for a conventional microcontroller to fail realizing multiple-times programming function with the system codes.

Since the system code CDS is mainly generated by the first code CD1, the user can generate invariable or primary codes in the system code CDS through the first code CD1 and generate variable or secondary codes in the system code CDS through the second codes. Besides, in the embodiment, the storage space of the first storage unit 240 is relatively greater than the storage spaces of the second storage units 251-253 so as to store the invariable or primary codes in the system code CDS. For example, the storage space (12 KB) of the first storage unit 240 can triple the storage space (4 KB) of each of the second storage units 251-253. In this way, along with the compression of the storage spaces of the second storage units 251-253, the advantage of the embodiment is not only realizing multiple-times programming function, but also taking the hardware cost of the microcontroller 200 into account as well.

For further reducing the hardware cost of the microcontroller 200, the first storage unit 240 and the second storage units 251-253 are allowed to be written once only. For example, the first storage unit 240 and the second storage units 251-253 are respectively an OTP memory. In the embodiment, the memory 220 can be, for example, a SRAM. However, the above-mentioned implementations for the first storage unit 240, the second storage units 251-253 and the memory 220 do not limit the present invention. In fact, people having ordinary skills in the art can modify the implementation patterns for the first storage unit 240, the second storage units 251-253 and the memory 220 according to the design requirements.

In summary, the present invention uses the multiplexer for switching the first storage unit and the second storage units to write the first code and one of the second codes into the memory so that the present invention is able to use the first code and different second codes for updating the system code. In addition, since the system code is mainly composed by the first code, so that the storage space of each of the second storage units for accessing the second codes can be relatively compressed, which further reduces the hardware cost of the microcontroller.

It will be apparent to those skilled in the art that the descriptions above are several preferred embodiments of the present invention only, which does not limit the implementing range of the present invention. Various modifications and variations can be made to the structure of the present invention without departing from the scope or spirit of the invention.

What is claimed is:

1. A microcontroller, comprising:
a memory;
a first storage unit for being written with a first code into;
a plurality of second storage units for being written with a plurality of second codes into;
a multiplexer, writing the first code and one of the second codes into the memory according to a control signal, so that the memory generates a system code; and
a micro-controller unit, reading out the system code come from the memory so as to perform operations.

2. The microcontroller as claimed in claim 1, wherein the storage space of the first storage unit is respectively greater than the storage space of each of the second storage units.

3. The microcontroller as claimed in claim 1, wherein the storage space of the first storage unit is three times of each of the storage space of each of the second storage units.

4. The microcontroller as claimed in claim 1, wherein the multiplexer comprises a first input terminal, a plurality of second input terminals and an output terminal, the first input terminal is coupled to the first storage unit, the second input terminals are coupled to the second storage units, the output terminal is coupled to the memory, and the multiplexer selects one of the second input terminals according to the control signal, and sequentially conducts the first input terminal and the selected second input terminal to the output terminal.

5. The microcontroller as claimed in claim 1, wherein the first storage unit and the second storage units are respectively written once only.

6. The microcontroller as claimed in claim 1, wherein the first storage unit and the second storage units are respectively a one-time programmable memory.

7. The microcontroller as claimed in claim 1, wherein the memory is a static random access memory.
